(19) United States
(12) Patent Application Publication
(10) Pub. No.: US 2014/0147541 A1
(43) Pub. Date: May 29, 2014

(54) OPERATING UNIT FOR INJECTION MOLDING MACHINE

(71) Applicant: ENGEL AUSTRIA GmbH, Schwertberg (AT)

(72) Inventors: Rainer HOELZL, Tragwein (AT); Albin KERN, Schwertberg (AT); Johann VOGGENEDER, Mauthausen (AT); Markus WAHLMUELLER, Au/Donau (AT)

(73) Assignee: ENGEL AUSTRIA GmbH, Schwertberg (AT)

(21) Appl. No.: 14/088,864

(22) Filed: Nov. 25, 2013

(30) Foreign Application Priority Data
Nov. 26, 2012 (AT) 1241/2012

(51) Int. Cl. B29C 45/76

(52) U.S. Cl. CPC B29C 45/76
USPC 425/162

(57) ABSTRACT

An operating unit has a display screen, a data processing device, and at least one hand button for the operation of injection molding machine elements. Items of information which are associated with injection molding elements and which are present in the injection molding machine can be called up by the data processing device. Items of status information which are associated with injection molding elements and which are present in the injection molding machine can be called up by the data processing device. Upon actuation of the at least one hand button, if the status information associated with the corresponding injection molding machine element indicates activatability, at least one operating signal can be sent to the injection molding machine and the associated items of information can be represented on the display screen. Otherwise, the associated items of information and a warning indication indicating non-activatability can be represented.

The present invention concerns an operating unit for an injection molding machine having the features of the classifying portion of claim 1, and an injection molding machine having such an operating unit.

Operating units of injection molding machines usually include a display screen and one or more hand keys or buttons. Those hand buttons serve for operation of elements of the injection molding machine including automation elements and directly trigger movements or other actions of the injection molding machine elements if movement is possible in the prevailing operating condition. Examples of injection molding machine elements which are to be controlled in that way are for example the injection unit, quick-action devices, pressure build-up devices and locking mechanisms. The display screen serves inter alia to represent many parameters which are to be set like for example maximum clamping force, metering volume or an opening travel. An operating unit of the general kind is to be found for example in AT 509 779 A1 to the present applicant.

It can happen that certain movements or actions cannot be carried out because the prerequisites for same are not present. A simple example would be when the attempt were made to begin an injection operation, without the closing pressure having been built up. Because of the high level of complexity of modern injection molding machines it may be difficult to see why a certain movement is being prevented. The operator then either has to navigate in the operating program to the sub-systems in question and check same, or work through a list of alarm messages.

The object of the invention is to provide an operating unit for an injection molding machine which saves the operator a search for corresponding items of information or warnings, upon actuation of a hand button. The invention further seeks to provide an injection molding machine having such an operating unit.

That object is attained by an operating unit having the features of claim 1 and an injection molding machine having the features of claim 5.

That is achieved in that items of status information which are associated with injection molding elements and which are present in the injection molding machine, in regard to activatability or non-activitability of the associated injection molding machine element, can be called up by the data processing device, and upon actuation of the at least one hand key or button, if the status information associated with the corresponding injection molding machine element indicates activatability, at least one operating signal can be sent to the injection molding machine element and the associated items of information can be represented on the display screen or, if the status information associated with the corresponding injection molding machine element indicates non-activitability, the associated items of information and a warning indication indicating the non-activatability can be represented on the display screen. If therefore the desired movement can be implemented all required items of information are immediately ready for the operator. If the movement is not possible the operator is guided to the cause without being required to search for it.

It is possible that the associated items of information are displayed only during the period of actuation of the hand button or that the items of information remain displayed for a period of time after actuation.

Further advantageous embodiments of the invention are defined in the appendant claims.

In injection molding machines having an operating unit which has a touch-sensitive display screen the hand buttons can be not only in the form of physical keys or buttons but also in the form of touch-sensitive regions on the display screen.

To make operation as intuitive as possible it can be provided that the items of information and/or the warning indication can be displayed in a display region directly adjoining the hand buttons, in which case the display region can preferably be arranged above the at least one hand button.

The items of information to be displayed can inter alia also be various parameters which can be represented as a digit and/or in the form of a bar representation and/or in the form of a diagram. The most appropriate form of display can therefore be individually selected for each parameter.

Protection is also claimed for an injection molding machine having an operating unit according to the invention.

Further advantages and details will be apparent from the Figures and the related specific description. In the Figures:

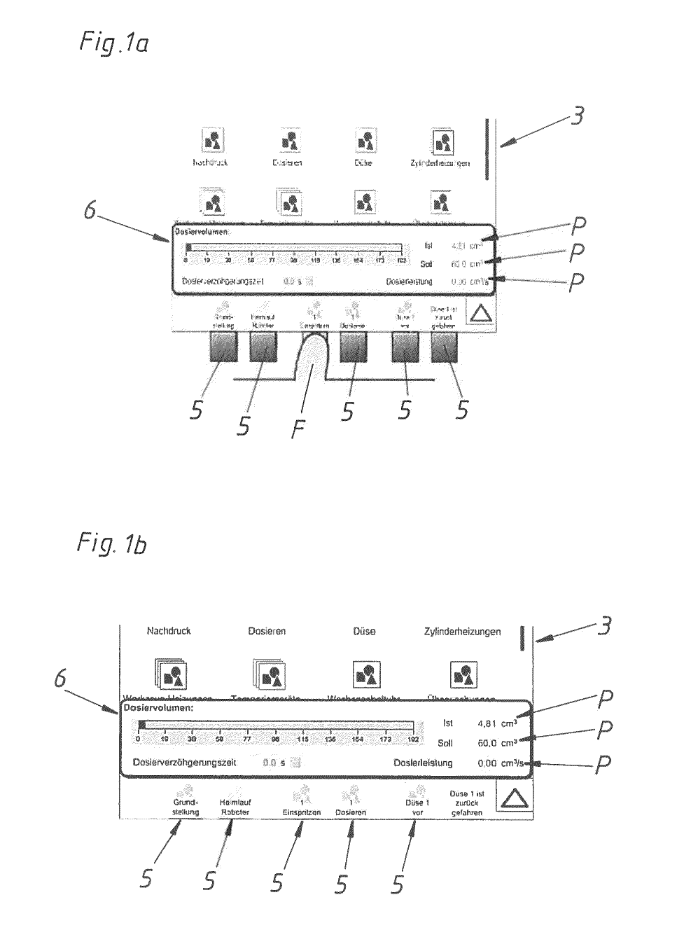

FIG. 1a shows a possible configuration of the information display with physical hand buttons,

FIG. 1b shows a similar configuration with hand buttons integrated in the touch screen,

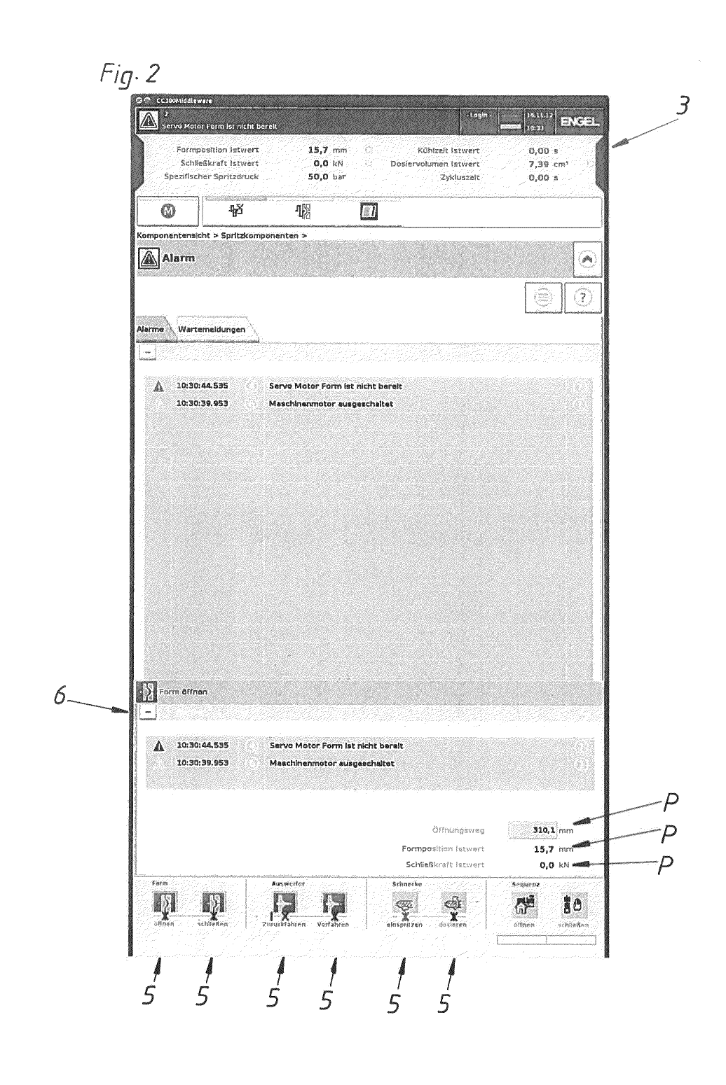

FIGS. 2 through 5 show various examples of the represented information and optionally warning indications, and

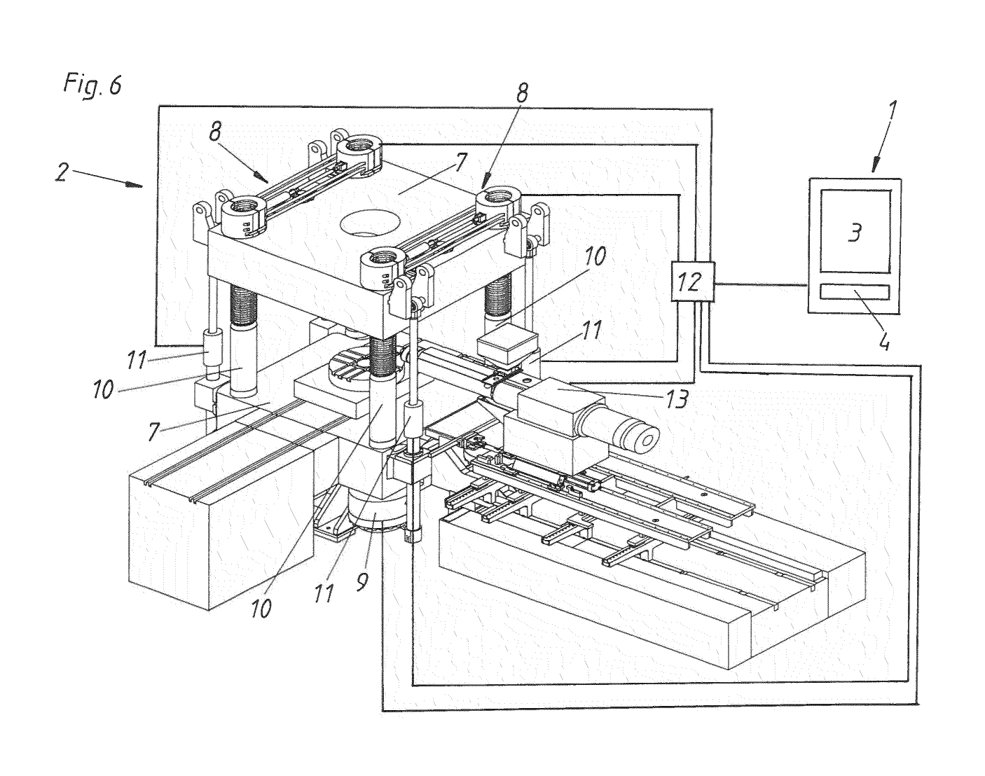

FIG. 6 shows an injection molding machine having an operating unit according to the invention.

FIG. 1a shows a first possible configuration of the representation of information on the display screen 3. As can be seen here a representation region 6 is displayed by the actuation of a hand button 5 by the finger F of an operator. Various parameters P can be represented in the region 6 in the form of a bar representation and in the form of digits. As in this example the hand button is actuated for the injection process for example the present metering volume and a target metering volume are displayed.

In the following Figures the finger F of the operator, that is to say actuation of the hand button, is no longer explicitly represented, but is of course a prerequisite for the warning indications or items of information represented in the Figures.

FIG. 1b shows an embodiment similar to FIG. 1a, wherein in this case the hand buttons 5 are in the form of touch-sensitive regions on the display screen 3.

FIGS. 2 through 5 show an alternative form of representation of the items of information, in which respect they are represented for various hand buttons associated with injection molding elements.

FIG. 2 concerns opening of the mold, in which respect here the movement is not possible as the servomotor in question is not ready or the machine motor is switched off. An opening travel, an instantaneous position of the mold and a closing force are represented as parameters.

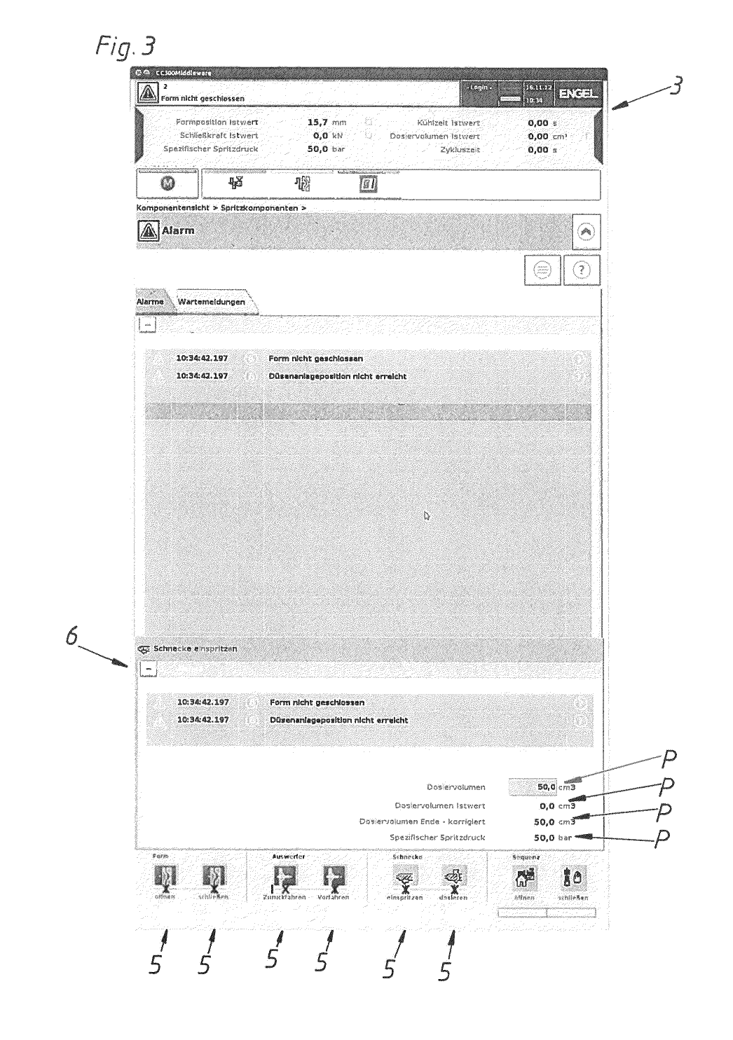

FIG. 3 concerns injection by the screw member. In this case also the movement is not possible as the mold is not closed and the nozzle installation position is not reached. Here too predetermined, currently prevailing and corrected metering volumes and an injection pressure are represented in the Figure.

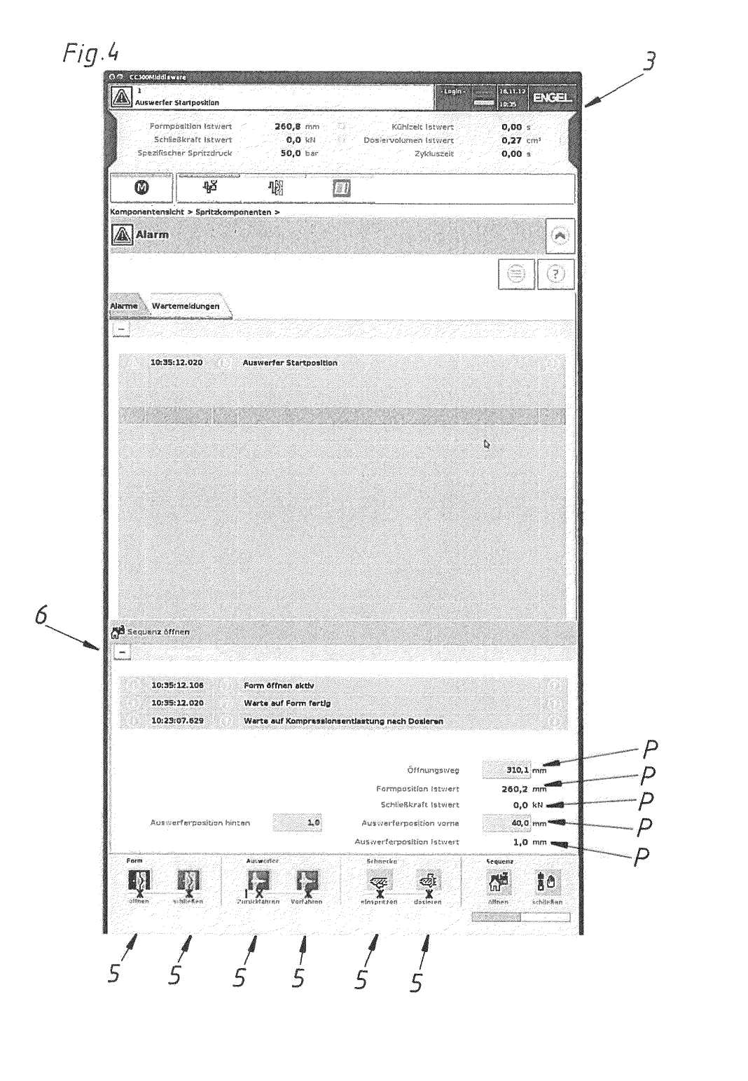

FIG. 4 concerns a hand button which triggers a motion sequence, in this case for opening the mold. The movement is possible in this case, wherein the arrangement indicates to the operator the movements which are still ready to be performed to be able to terminate the sequence. In this case also some parameters are again represented: an opening travel, a mold position actual value, a closing force actual value, a rear and a front ejector position and an ejector position actual value.

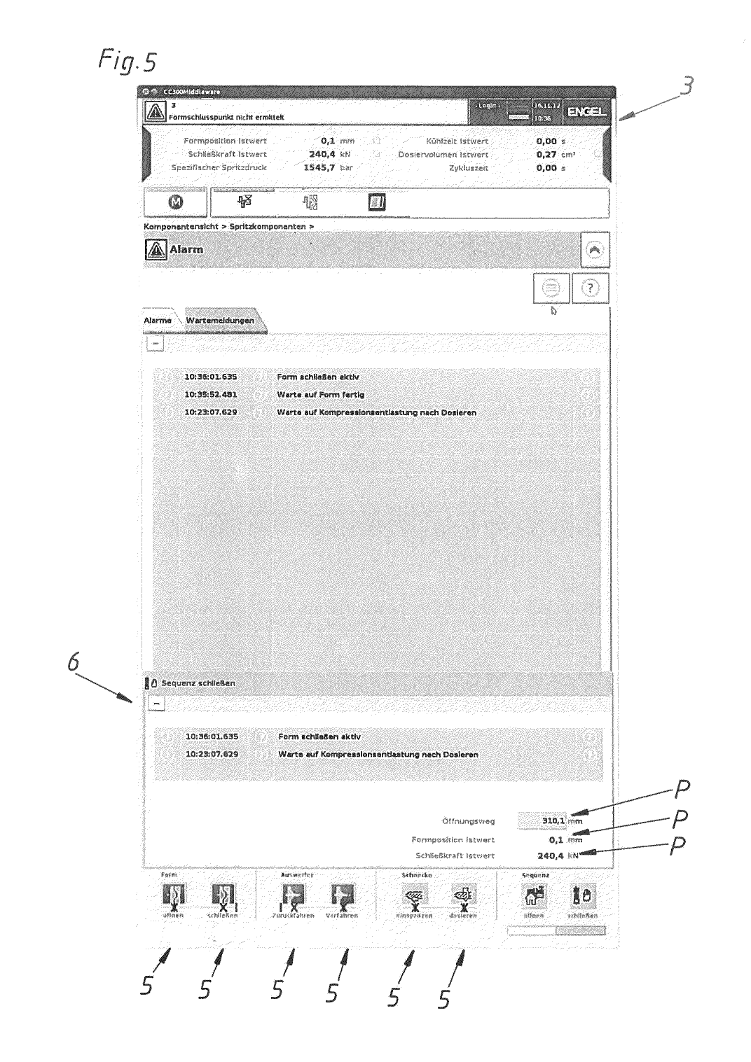

A similar situation is shown in FIG. 5, wherein a sequence for closing the closing unit is performed here. In this case the illustrated parameters are an opening travel, a mold position actual value and a closing force actual value.

FIG. 6 shows an injection molding machine 2 having an operating unit 1 according to the invention which has a display screen 3 and a data processing device 4.

This Figure shows an injection molding machine having a vertically closing closing unit, this however is not relevant per se to the invention. In this case the injection molding machine has mold mounting plates 7 and bar members 10. The Figure further diagrammatically shows a control or regulating device 12 connected to the locking mechanisms 8, the quick-action devices 11, the pressure build-up mechanisms 9 and the injection unit 13.

Because of the perspective view of the injection molding machine 2 it is not possible for all the elements present to be provided with reference numerals, although naturally those elements are nonetheless present.

In this case the connection of the injection molding machine to the operating unit 1 is implemented by way of a connection between the control or regulating device 12 and the operating unit 1. It is naturally also possible for the operating unit to be connected directly to the injection molding machine elements or for the control or regulating device 12 to be in the form of a single item of equipment with the data processing device 4.

1. An operating unit for an injection molding machine having a display screen, a data processing device and at least one hand button for the operation of injection molding machine elements, wherein items of information which are associated with injection molding elements and which are present in the injection molding machine can be called up by the data processing device, characterised in that items of status information which are associated with injection molding elements and which are present in the injection molding machine in respect of activatability or non-activatability of the associated injection molding machine element can be called up by the data processing device and that upon actuation of the at least one hand button, if the status information associated with the corresponding injection molding machine element indicates activatability, at least one operating signal can be sent to the injection molding machine and the associated items of information can be represented on the display screen or, if the status information associated with the corresponding injection molding machine element indicates non-activatability, the associated items of information and a warning indication indicating non-activatability can be represented on the display screen.

2. An operating unit as set forth in claim 1 characterised in that the display screen is touch-sensitive and preferably the at least one hand button is in the form of a touch-sensitive region on the touch-sensitive display screen.

3. An operating unit as set forth in claim 1 characterised in that the items of information and/or the warning indication can be represented in a representation region directly adjoining the hand buttons, wherein the representation region can preferably be arranged above the at least one hand button.

4. An operating unit as set forth in claim 1 characterised in that the items of information include parameters which can be represented as a digit and/or in a bar form of representation and/or in the form of a diagram.

5. An injection molding machine having an operating unit as set forth in claim 1.

6. An operating unit as set forth in claim 2 characterised in that the items of information and/or the warning indication can be represented in a representation region directly adjoining the hand buttons, wherein the representation region can preferably be arranged above the at least one hand button.

7. An operating unit as set forth in claim 2 characterised in that the items of information include parameters which can be represented as a digit and/or in a bar form of representation and/or in the form of a diagram.

8. An operating unit as set forth in claim 3 characterised in that the items of information include parameters which can be represented as a digit and/or in a bar form of representation and/or in the form of a diagram.

9. An injection molding machine having an operating unit as set forth in claim 2.

10. An injection molding machine having an operating unit as set forth in claim 3.

11. An injection molding machine having an operating unit as set forth in claim 4.
